(19) United States
(12) Patent Application Publication
(10) Pub. No.: US 2018/0235272 A1
(43) Pub. Date: Aug. 23, 2018

(54) APPARATUS AND METHOD FOR CRACKING MACADAMIA NUTS

(71) Applicant: CH Precision Pty Ltd, Acacia Ridge, Queensland (AU)

(72) Inventor: Richard Grant TOVEY, Acacia Ridge, Queensland (AU)

(21) Appl. No.: 15/759,887

(22) PCT Filed: Sep. 14, 2016
(86) PCT No.: PCT/AU2016/050856

§ 371 Date: Mar. 14, 2018

(30) Foreign Application Priority Data
Sep. 15, 2015 (AU) 2015903751

(51) Int. Cl. A23N 5/00; A47J 43/26

(52) U.S. Cl. CPC A23N 5/00; A47J 43/26

(57) ABSTRACT

An apparatus for cracking nuts comprises a mounting structure, a circular element, a chute and a drive mechanism. The circular element has a tapered edge for scoring a nutshell and is rotatably supported by the mounting structure. The chute is positioned adjacent to the tapered edge of the circular element and has a rear wall. A distance between the rear wall of the chute and the tapered edge of the circular element gradually decreases along a length of the chute. The drive mechanism is connected to the circular element for rotating the circular element relative to the chute. In use, the circular element is rotated relative to the chute and a nut is received in the chute. The nut is pinched between the tapered edge of the circular element and the rear wall of the chute. Rotation of the circular element rolls the nut along the chute and scores the nutshell along an equator of the nutshell with a channel that becomes progressively deeper as the nutshell rolls further along the length of the chute.

### BACKGROUND TO THE INVENTION

Nuts, and macadamia nuts in particular, are often difficult to crack without damaging the soft nut meat contained in the nutshell. Macadamia nut shells are typically very thick, hard and brittle, and the nut fits very tightly inside the nutshell. In fact, macadamia nuts are considered to be one of the toughest nuts to crack, taking up to 2000 kiloPascals of pressure to crack.

Existing technologies, of which there are many, for cracking and shelling macadamia nuts include devices ranging from simple manual tools which resemble pliers, to sophisticated and complex motorised systems for commercial use.

A first substantial problem faced by many mechanical and automated nut-cracking systems is the application of force to a nut. It is critical that the cracking means applies force to the nut with enough magnitude to crack the shell while leaving the nut meat undamaged and uncrushed. Many methods and devices for cracking and extracting nuts also result in the nutshell shattering and damaging the soft nut meat. This is undesirable as whole, undamaged nut kernels are generally sold for a greater sale price than fragmented kernels.

Further complicating the nut cracking procedure, macadamia nuts are of a varying size so an effective cracking mechanism generally must be able to accommodate a variety of circumferences of macadamia nuts. There are numerous tools which attempt to overcome the problems described above. However, such tools are generally either very simple systems that are manually operated and that cannot be effectively scaled to process large quantities of nuts, or highly sophisticated and complex systems that are expensive and require substantial maintenance.

Commonly, in a domestic environment, people crack individual nuts by first placing a nut in a small crack or divot in cement or another hard surface to hold the nut, and then using a hammer to crack the nutshell so that the nut meat can be removed. This can be dangerous and result in damaged feet or hands if proper care is not taken. Alternatively, a person may place the nut in a vice and tighten the vice until the nutshell cracks. Both methods involve guessing with regard to how much force should be applied to the nutshell and can often result in the shell being severely crushed along with the delicate nut meat.

One known prior art device clamps the macadamia nut between a screw and a hard surface. The screw is twisted and a point on the distal end of the screw is driven into the nutshell, causing it to splinter and crack and releasing the nut meat. An alternative device includes a pliers-like device that uses a scissor mechanism actuated by a user's hand to crush the nut. While simple manual tools such as those described can crack a nut shell while minimising any damage to the nut meat, these types of tools are usually not suitable for high volume nut cracking.

An alternative device includes placing the nut between two plates (similar to a small vice) that are actuated by a lever which, when pulled, causes the two plates to compress the nut and crack the shell. This type of device is more suited to higher volume cracking but can still suffer from ejected shell debris and is not necessarily suited to varying macadamia nut circumferences.

Many commercial nut shelling apparatus provide a constant feed of nuts to a cracking machine that uses a large drum or plate to fracture or crush the nut shell so that the nut meat can be extracted in a separate operation. This is both costly and inefficient, and often results in a crushed or damaged nut meat.

There is therefore a need for an improved apparatus and method for cracking macadamia nuts while incurring minimal damage to the delicate nutmeat.

### SUMMARY OF THE INVENTION

According to one aspect, the invention is an apparatus for cracking nuts, the apparatus comprising:

a mounting structure;

a circular element having a tapered edge for scoring a nutshell, the circular element rotatably supported by the mounting structure;

a chute positioned adjacent to the tapered edge of the circular element and having a rear wall, wherein a distance between the rear wall of the chute and the tapered edge of the circular element gradually decreases along a length of the chute; and

a drive mechanism connected to the circular element for rotating the circular element relative to the chute;

whereby when the circular element is rotated relative to the chute and a nut is received in the chute, the nut is pinched between the tapered edge of the circular element and the rear wall of the chute, and rotation of the circular element rolls the nut along the chute and scores the nutshell along an equator of the nutshell with a channel that becomes progressively deeper as the nutshell rolls further along the length of the chute.

Preferably, the chute is a curved chute.

Preferably, the curved chute is defined by a middle plate, a first side plate and a second side plate.

Preferably, the first side plate is bolted to the second side plate.

Preferably, the circular element is mounted between the first side plate and the second side plate.

Preferably, the curved chute is vertically oriented whereby in use nuts are forced by gravity along the curved chute.

Preferably, the rear wall of the curved chute includes a protruding tapered edge for scoring the nutshell.

Preferably, the protruding tapered edge of the rear wall is axially aligned with the tapered edge of the circular element.

Preferably, the drive mechanism includes a gear for driving the circular element.

Preferably, the apparatus includes a hopper that feeds the nuts to the curved chute.

Preferably, the apparatus further comprises:

a plurality of circular elements, each circular element having a tapered edge for scoring a nutshell; and

a plurality of curved chutes.

Preferably, the plurality of circular elements are axially aligned.

Preferably, each curved chute in the plurality of curved chutes is positioned at a different distance from a corresponding circular element than each other curved chute; whereby in use each curved chute receives nuts having a different size range than each other curved chute.

Preferably, a plurality of hoppers are connected to the plurality of curved chutes, whereby in use each hopper in the plurality of hoppers receives nuts having a different size range than each other hopper.

Preferably each different size range of nuts is defined by a nut diameter range.

Preferably, the drive mechanism includes a handle.

Preferably, the mounting structure and the curved chute are integrally formed with a body of the apparatus.

Preferably, the apparatus further comprises a base plate.

Preferably, the drive mechanism is hand operated.

Preferably, the drive mechanism is motor operated.

Preferably, the circular element is a spoked wheel.

Preferably, a housing encloses the mounting structure, the circular element, and the curved chute.

According to another aspect, the invention is a method of cracking nuts that employs the features of the above described apparatus.

### BRIEF DESCRIPTION OF THE DRAWINGS

To assist in understanding the invention and to enable a person skilled in the art to put the invention into practical effect, preferred embodiments of the invention are described below by way of example only with reference to the accompanying drawings, in which:

FIG. 1 shows a perspective view of an apparatus for cracking nuts according to a first embodiment of the present invention;

FIG. 2 shows a side view of the apparatus of FIG. 1;

FIG. 3 shows an underside view of the apparatus of FIG. 1;

FIG. 4 shows a top view of the apparatus of FIG. 1;

FIG. 5 shows an end view of the apparatus of FIG. 1;

FIG. 6 shows a perspective view of an apparatus for cracking nuts according to a second embodiment of the present invention;

FIG. 7 shows a perspective view of an apparatus for cracking nuts according to a third embodiment of the present invention;

FIG. 8 shows a perspective view of an apparatus for cracking nuts according to a fourth embodiment of the present invention;

FIG. 9 shows a perspective view of an apparatus for cracking nuts according to a fifth embodiment of the present invention;

FIG. 10 shows a perspective view of an apparatus for cracking nuts according to a sixth embodiment of the present invention;

FIG. 11 shows a perspective view of an apparatus for cracking nuts according to a seventh embodiment of the present invention; and

FIG. 12 shows a perspective view of an apparatus for cracking nuts according to an eighth embodiment of the present invention.

### DETAILED DESCRIPTION OF THE PREFERRED EMBODIMENT

The present invention relates to an apparatus for cracking macadamia nuts. Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

In this patent specification, adjectives such as first and second, left and right, top and bottom, upper and lower, rear, front and side, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

According to one aspect, the present invention is defined as an apparatus for cracking nuts. The apparatus comprises a mounting structure and a circular element. The circular element has a tapered edge for scoring a nutshell. Further, the circular element is rotatably supported by the mounting structure. The apparatus further comprises a curved chute positioned adjacent to the tapered edge of the circular element. The curved chute has a rear wall wherein a distance between the rear wall of the curved chute and the tapered edge of the circular element gradually decreases along a length of the chute. The apparatus also comprises a drive mechanism. The drive mechanism is connected to the circular element for rotating the circular element relative to the curved chute. In use, the circular element is rotated relative to the curved chute. A nut is received in the chute and the nut is pinched between the tapered edge of the circular element and rear wall of the curved chute. The rotation of the circular element rolls the nut along the curved chute and scores the nutshell along an equator of the nutshell with a channel that becomes progressively deeper as the nutshell rolls further along the length of the chute.

A person skilled in the art will understand that the term scoring in this specification is to be interpreted broadly and includes scoring, effecting a groove, cutting, impressing and a hobbing-like process for opening a nutshell.

Advantages of some embodiments of the present invention include an apparatus which scores and cracks a nutshell without damaging the delicate nut meat inside the nutshell. Further, nutshells are generally neatly divided in two along the equator of the nutshell, leaving fewer shell fragments requiring separation from the nut meat. Also, alternative designs of various embodiments of the present invention can be widely varied from small, manually operated machines that can be entertaining and fun to operate in a home or store environment, to large, automated machines that can efficiently process high volumes of nuts of varying sizes.

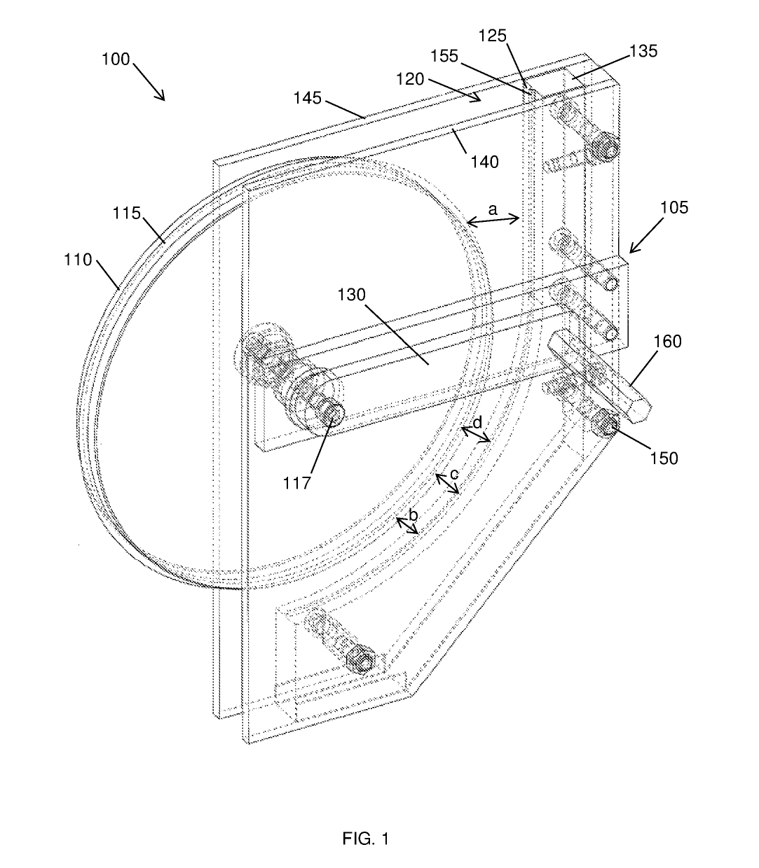

FIG. 1 shows a perspective view of an apparatus for cracking nuts 100 comprising a mounting structure 105 and a circular element 110 in the form of a disk. The circular element 110 has a tapered edge 115 for pressing into and scoring a nutshell (not shown). Further, the circular element 110 is rotatably supported by the mounting structure 105 using an axle 117. The apparatus 100 further comprises a curved chute 120 positioned adjacent to the tapered edge 115 of the circular element 110. The curved chute 120 has a rear wall 125 wherein a distance between the rear wall 125 of the curved chute 120 and the tapered edge 115 of the circular element 110 gradually decreases along a length of the chute 120. For example, as shown in FIG. 1, a wide distance “a” at the mouth of the chute 120 gradually decreases to a minimum distance “b” near an exit of the chute 120.

The apparatus 100 also comprises a drive mechanism in the form of a crank arm 130. The crank arm 130 is connected to the circular element 110 for rotating the circular element 110 relative to the curved chute 120. As a nut (not shown) is received in the curved chute 120 of the apparatus 100, the nut is pinched between the tapered edge 115 of the circular element 100 and the rear wall 125 of the curved chute 120. The rotation of the circular element 110 rolls the nut along the curved chute 120 and scores the nutshell along an equator of the nutshell. As the nut progresses along the narrowing chute 120, a channel or groove formed in the nutshell by the tapered edge 115 becomes progressively deeper up to a maximum depth at point “b” where the distance between the tapered edge 115 and the rear wall 125 is at a minimum.

The distance “b” can be adjusted so that a particular size range of nutshells will be severed into two halves just before a nut reaches the point in the chute 120 where the minimum distance “b” occurs. That ensures that the tapered edge 115 effectively and consistently severs nut shells having a diameter within a given size range, but does not damage the nut meat of a severed nut. For example, a curve of the chute 120 and the distance “b” can be adjusted so that the apparatus 100 effectively cracks or splits open nutshells having an inner diameter anywhere between a maximum distance “c” and the minimum distance “b”. Nutshells having an inner diameter larger than distance “c” generally will not be effectively processed by the apparatus as the nut meat inside such larger nut shells would be damaged as the shell and meat rolls further along the chute 120. In some embodiments of the apparatus 100, the curved chute 120 is defined by a middle plate 135, a first side plate 140 and a second side plate 145. For example, the first side plate 140 can be connected to the second side plate 145 using bolts 150, enabling the apparatus 100 to be easily and effectively disassembled for adjustment or for cleaning. Alternatively, a person skilled in the art will appreciate that the middle plate 135, the first side plate 140 and the second side plate 145 can be secured together by glue, welding or another suitable securing means. The middle plate 135, the first side plate 140 and the second side plate 145 can also be integrally formed from various materials including steel, plastic or wood. The axle 117 also can be mounted between the first side plate 140 and the second side plate 145 using a nut and bolt configuration or another suitable mounting mechanism.

The curved chute 120 is generally vertically oriented such that in use, nuts are forced by gravity along the curved chute 120. In some embodiments of the apparatus 100, the rear wall 125 of the curved chute 120 also includes a protruding tapered edge 155 for scoring the nutshell. The protruding tapered edge 155 of the rear wall 125 is similar in shape to and axially aligned with the tapered edge 115 of the circular element 110. The dual wedging action of the tapered edges 115, 155 can assist in efficiently splitting a nutshell while effectively holding and rolling a nutshell along the chute 120 without slippage.

For example, nuts having an outer diameter “d” that are received at the top of the chute 120 may roll along the chute 120 freely until they reach the point in the chute having a distance “d” between the tapered edge 115 and the tapered edge 155, where the nut is pinched between the tapered edges 115, 155. As the circular element 110 rotates, both tapered edges 115, 155 gradually work into the nut until the nutshell is severed into two halves at a point somewhere between distances “b” and “c”.

Preferably, the crank arm 130 includes a handle 160 which can be hand operated. In use, a user can use the handle 160 to rotate the circular element 110 relative to the curved chute 120 to roll a nut along the curved chute 120.

Those having ordinary skill in the art will appreciate that the various elements of the apparatus 100 can be modified to conform to various shapes and sizes, and can be manufactured from a variety of materials including metals, polymers and wood.

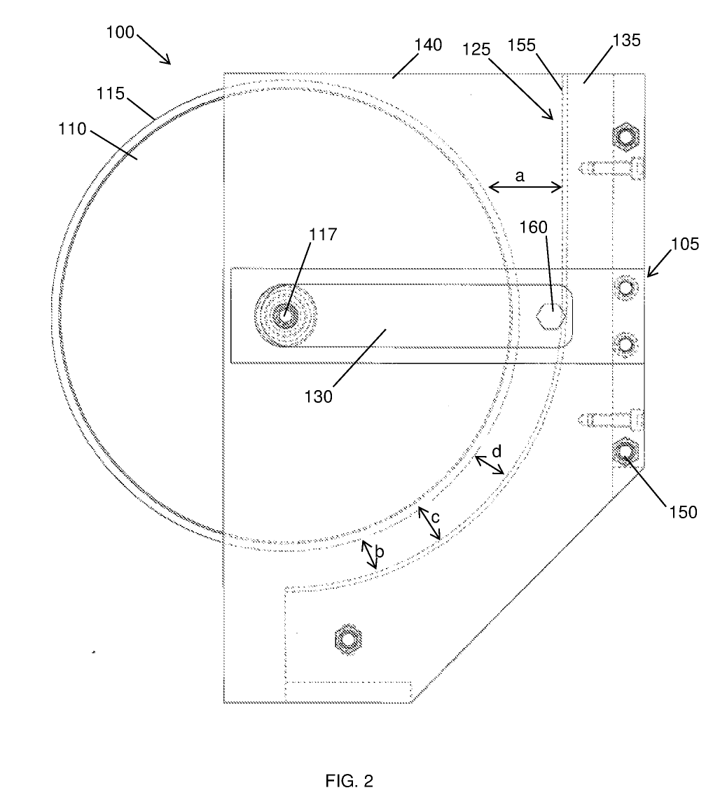

FIG. 2 shows a side view of the apparatus 100 of FIG. 1.

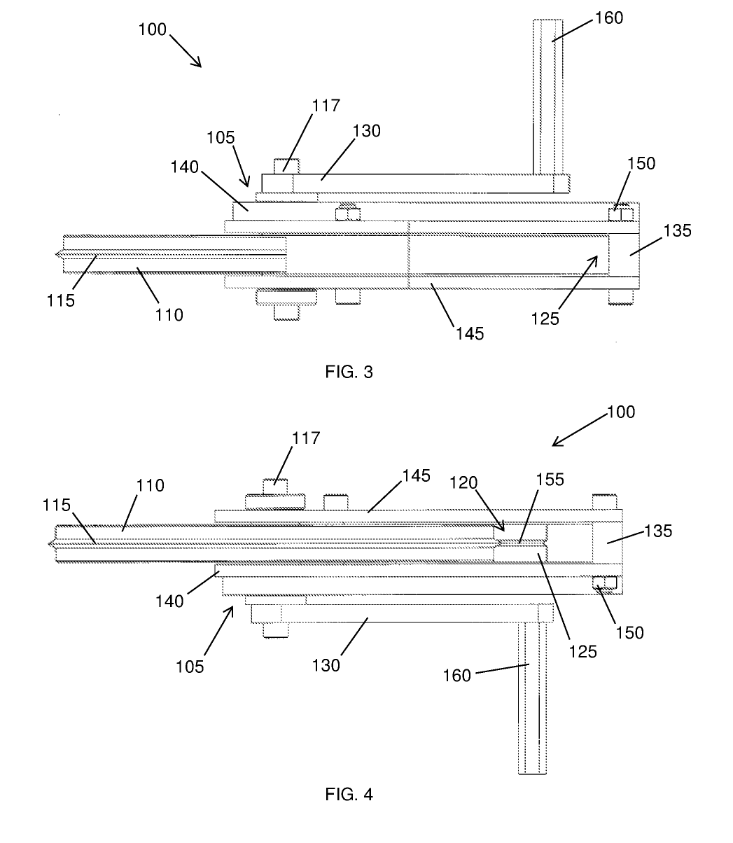

FIG. 3 shows an underside view of the apparatus 100 of FIG. 1.

FIG. 4 shows a top view of the apparatus 100 of FIG. 1.

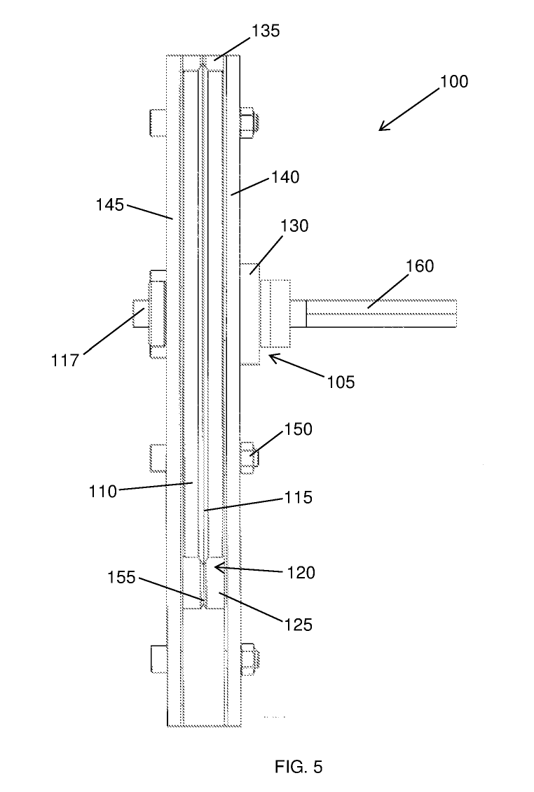

FIG. 5 shows an end view of the apparatus 100 of FIG. 1.

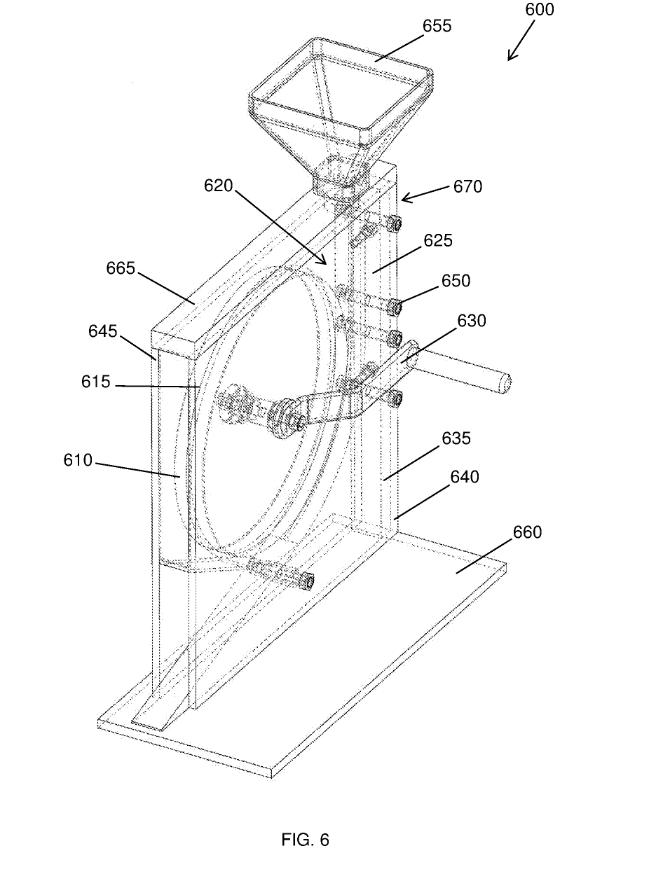

FIG. 6 illustrates a perspective view of an apparatus 600 for cracking nuts according to a second embodiment of the present invention. The embodiment shown in FIG. 6 is similar to the embodiment described in FIG. 1, including a mounting structure 605, a circular element 610, a tapered edge 615, a curved chute 620 having a rear wall 625 and a drive mechanism 630. The apparatus 600 also includes a middle plate 635, a first side plate 640, and a second side plate 645 which can be held together by bolts 650, as shown. However, the apparatus 600 also includes a hopper 655 that feeds the nuts to the curved chute 625, and a base plate 660 and a top plate 665 which are secured to the middle plate 635, the first side plate 640 and the second side plate 645. The plates 635, 640, 645, 660, 665 can be secured together using various means such as bolts, glue or a welding process or can be integrally formed. Advantageously, the hopper 655 allows a greater number of nuts to be fed into the apparatus at a continuous rate.

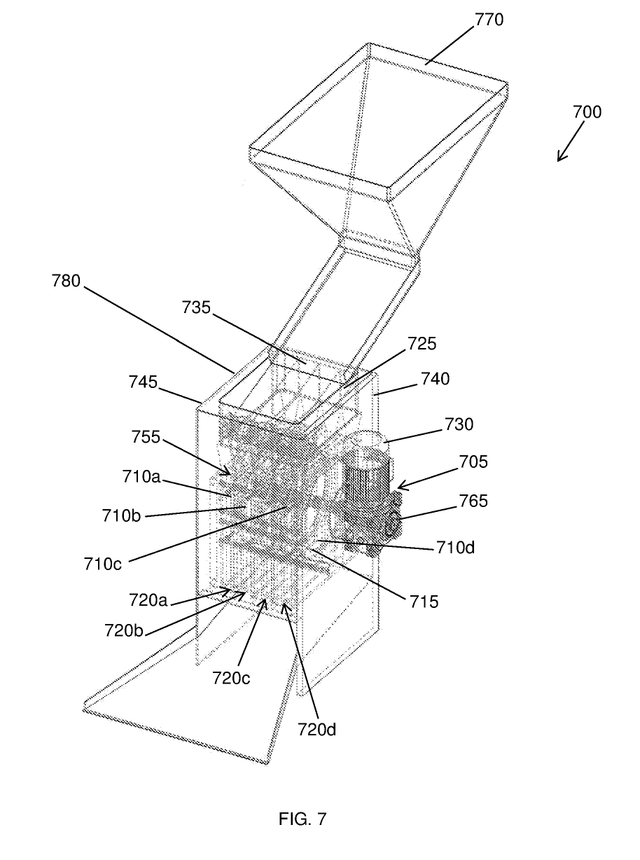

FIG. 7 illustrates a perspective view of an apparatus 700 for cracking nuts according to a third embodiment of the present invention. The embodiment shown in FIG. 7 is also similar to the embodiment described in FIG. 1, including an apparatus 700, a mounting structure 705, a circular element 710, a tapered edge 715, a curved chute 720a having a rear wall 725 and a drive mechanism 730. The apparatus 700 also includes a middle plate 735, a first side plate 740, and a second side plater 745 which can be held together by bolts (not shown), as described in FIG. 1.

However, the apparatus 700 further comprises three additional, axially aligned circular elements 710 to increase the nut processing capacity of the apparatus 700. Each of the four circular elements 710 has a tapered edge 755 for scoring a nutshell. The apparatus 700 also includes a plurality of curved chutes 720. Each curved chute 720a, 720b, 720c, 720d is positioned adjacent a corresponding circular element 710a, 710b, 710c, 710d, respectively.

The drive mechanism of the apparatus 700 includes a motor 765. As shown, the apparatus 700 also can include a hopper 770 for feeding nuts to each curved chute 720. Advantageously, the apparatus 700 does not require a user to operate the drive mechanism 730 by hand and the circular element 710 can be operated at a constant speed to allow a continuous feed of nuts to the apparatus 700 from the hopper 770. In some embodiments, the mounting structure 705 and the curved chute 720 are integrally formed with a body 780 of the apparatus 700. As shown, the mounting structure 705 is perpendicular to the middle plate 735. However, a person skilled in the art will appreciate that the mounting structure 605 can be secured to the body 780 at any angle relative to the middle plate 735.

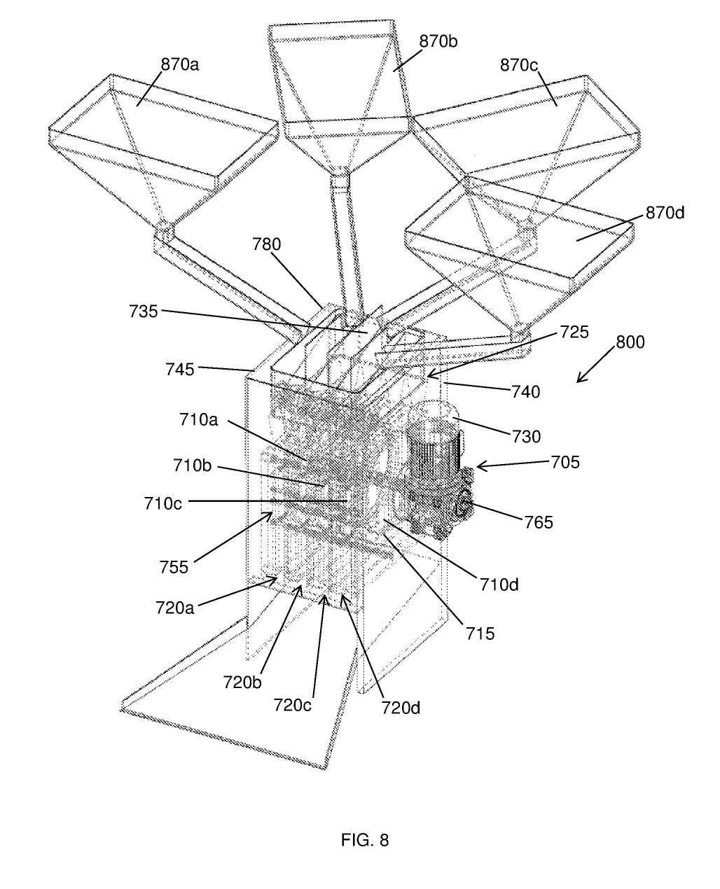

FIG. 8 shows a perspective view of an apparatus for cracking nuts according to a fourth embodiment of the present invention. The embodiment shown in FIG. 8 is as substantially the same as the embodiment shown in FIG. 7. However, the apparatus 800 includes a four hoppers 870a, 870b, 870d that are each connected to one of the curved chutes 720a, 720b, 720c, 720d, respectively. Advantageously, in use each hopper 870 receives nuts having a different size range than each other hopper 870. Each curved chute 720a, 720b, 720c, 720d is then positioned at a different distance from a corresponding circular element 710a, 710b, 710c, 710d, respectively, than each other curved chute 720a -d so that each curved chute 720a -d effectively processes nuts having a different size range than each other curved chute 720a -d. The apparatus 800 can thus process several size ranges of nuts simultaneously without the need for constant adjustments to the distance between a curved chute 720 and a circular element 710.

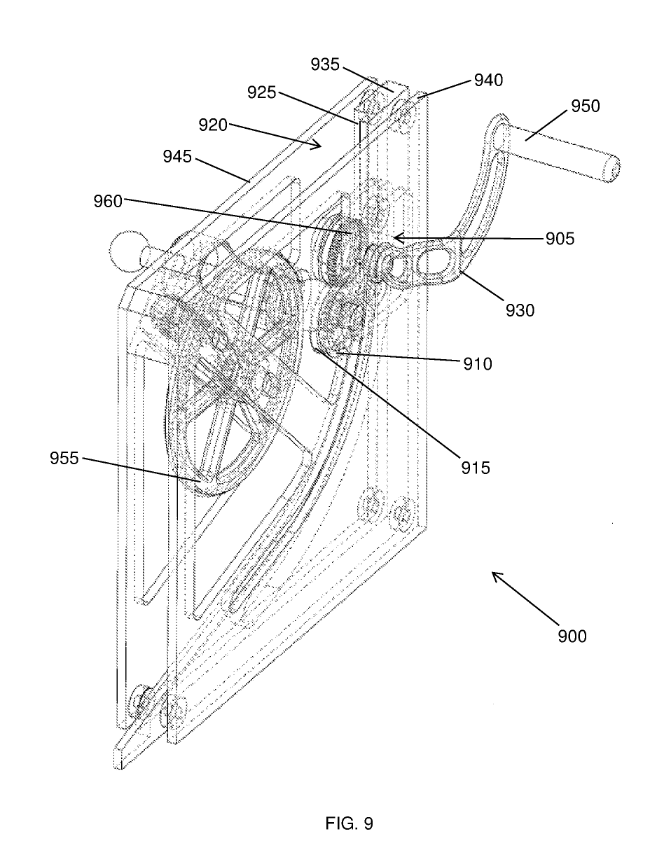

FIG. 9 illustrates a perspective view of an apparatus 900 for cracking nuts according to a fifth embodiment of the present invention. The embodiment shown in FIG. 9 is similar to the embodiment shown in FIG. 1, including a mounting structure 905, a circular element 910 in the form of a spoked wheel, a tapered edge 915, a curved chute 920 having a rear wall 925 and a drive mechanism 930. The apparatus 900 also includes a middle plate 935, a first side plate 940, and a second side plate 945 which can be bolted together, as described in FIG. 1. However, the drive mechanism includes a gear 960 for driving the circular element 910 and a handle 950 for driving the gear 960. In use, the handle 950 is rotated, which rotates the gear 960. The gear 960 then engages the circular element 910 and causes the circular element 910 to rotate. The apparatus 900 further incorporates guiding and aligning a nut to facilitate cracking of the nut shell.

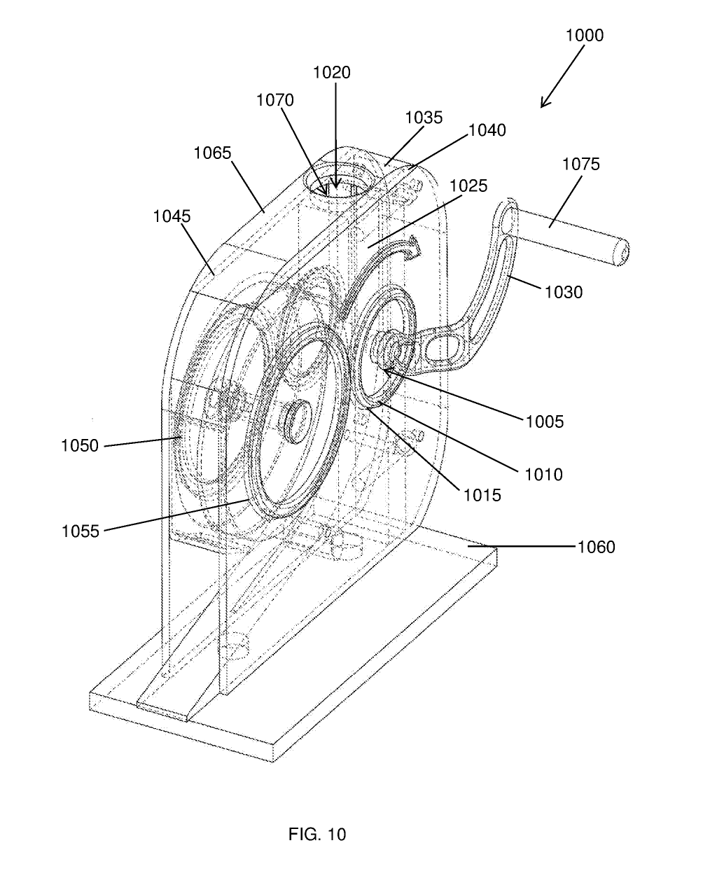

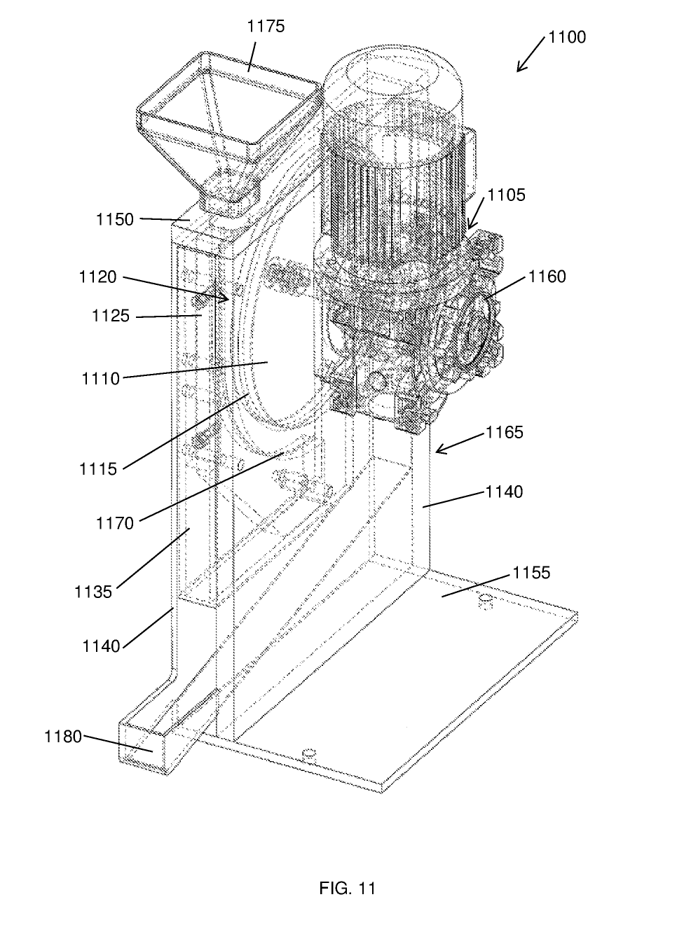

FIG. 10 illustrates a perspective view of an apparatus 1000 for cracking nuts according to a sixth embodiment of the present invention. The embodiment shown in FIG. 10 is similar to the embodiment shown in FIG. 1 including a mounting structure 1005, a circular element 1010, a tapered edge 1015, a curved chute 1020 including a rear wall 1025 and a drive mechanism 1030. The apparatus 1000 also includes a middle plate 1035, a first side plate 1040, and a second side plate 1045 which can be held together by bolts, as shown in FIG. 1. The apparatus 1000 also includes a base plate 1060 and a housing 1065 that encloses the mounting structure 1005, the circular element 1010, and the curved chute 1020. As shown, the apparatus 1000 can include a fixed second circular element 1050 including a tapered edge 1055 so that a nut can be fed into the apparatus via an opening 1070 in the housing 1065. The nut is then rolled between the two circular elements 1010, 1050 which score an equator of nutshell. Advantageously, the housing prevents shards of a cracked nut shell from being projected from the apparatus. FIG. 11 illustrates a perspective view of an apparatus 1100 for cracking nuts according to a seventh embodiment of the present invention. The embodiment shown in FIG. 11 is similar to the embodiment shown in FIG. 1, including a mounting structure 1105, a circular element 1110, a tapered edge 1115, and a curved chute 1120 having a rear wall 1125. The apparatus 1100 also includes a middle plate 1135, a first side plate 1140, and a second side plate 1145 which can be held together by bolts, as shown in FIG. 1. Some embodiments of the apparatus 1100 can include a top plate 1150 and a base plate 1155. Advantageously, the base plate provides a stable base for the apparatus 1100. Some further embodiments can include a housing 1165. As shown, the apparatus 1100 can include a motor operated drive mechanism 1160 and a hopper 1175 for receiving the nuts and feeding them into the curved chute 1120. The apparatus 1100 can also include a protruding tapered edge 1170 on the rear wall 1125 and a tray 1180 for receiving the separated nut shells and nut meat.

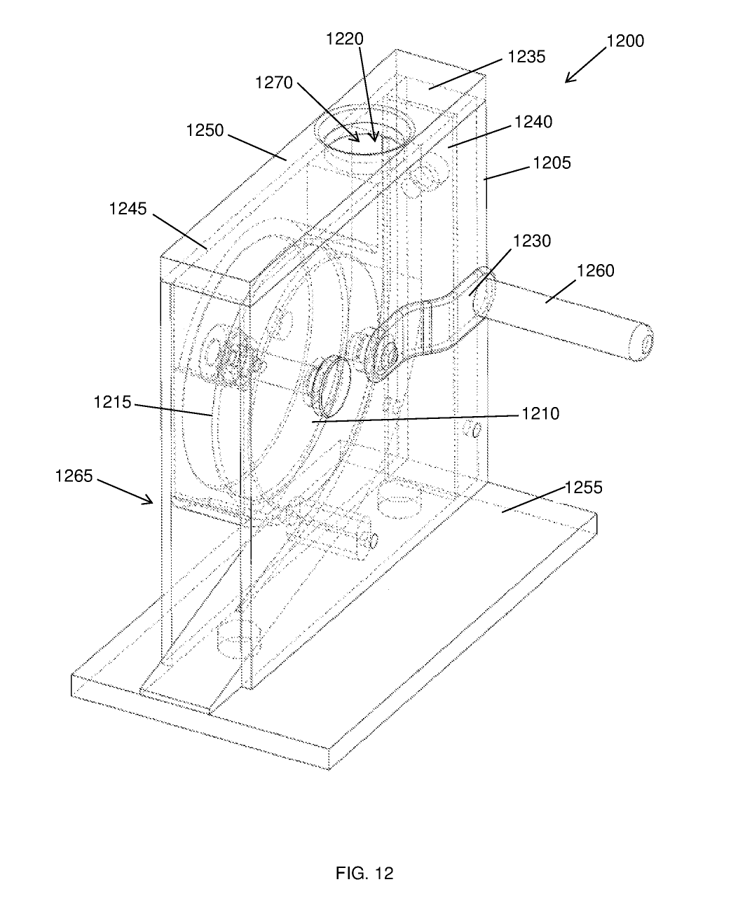

FIG. 12 illustrates a perspective view of an apparatus 1200 for cracking nuts according to an eighth embodiment of the present invention. The embodiment shown in FIG. 12 is similar to the embodiment shown in FIG. 1, including a mounting structure 1205, a circular element 1210, a tapered edge 1215, a curved chute 1220, a rear wall of the curved chute 1225 and a drive mechanism 1230. As shown, the circular element 1210 can be a drum-shaped element with a tapered edge 1215. The apparatus 1200 also includes a middle plate 1235, a first side plate 1240, and a second side plate 1245 which can be held together by bolts. Some embodiments of the invention can include a top plate 1250, a base plate 1255 and a handle 1260 connected to the drive mechanism 1230 in the form of a crank arm.

Further embodiments of the invention can include a housing (not shown) that encloses the mounting structure 1205, the circular element 1210 and the curved chute 1220. The housing can compromise various materials, for example, wood, metal, polymer or any other suitable material. Advantageously, the housing adds a level of increased safety to the apparatus and prevents small hands and fingers from becoming lodged in the apparatus.

The above description of various embodiments of the present invention is provided for purposes of description to one of ordinary skill in the related art. It is not intended to be exhaustive or to limit the invention to a single disclosed embodiment. Numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1. An apparatus for cracking nuts, the apparatus comprising:
a mounting structure;
a circular element having a tapered edge for scoring a nutshell, the circular element rotatably supported by the mounting structure;
a chute positioned adjacent to the tapered edge of the circular element and having a rear wall, wherein a distance between the rear wall of the chute and the tapered edge of the circular element gradually decreases along a length of the chute; and
a drive mechanism connected to the circular element for rotating the circular element relative to the chute;
whereby when the circular element is rotated relative to the chute and a nut is received in the chute, the nut is pinched between the tapered edge of the circular element and the rear wall of the chute, and rotation of the circular element rolls the nut along the chute and scores the nutshell along an equator of the nutshell with a channel that becomes progressively deeper as the nutshell rolls further along the length of the chute.

2. The apparatus of claim 1, wherein the chute is a curved chute.

3. The apparatus of claim 2, wherein the curved chute is defined by a middle plate, a first side plate and a second side plate.

4. The apparatus of claim 3, wherein the first side plate is bolted to the second side plate.

5. The apparatus of claim 3, wherein the circular element is mounted between the first side plate and the second side plate.

6. The apparatus of claim 2, wherein the curved chute is vertically oriented whereby in use nuts are forced by gravity along the curved chute.

7. The apparatus of claim 1, wherein the rear wall of the chute comprises a protruding tapered edge for scoring the nutshell.

8. The apparatus of claim 7, wherein the protruding tapered edge of the rear wall is axially aligned with the tapered edge of the circular element.

9. The apparatus of claim 1, wherein the drive mechanism comprises a gear for driving the circular element.

10. The apparatus of claim 2 further comprising a hopper that feeds the nuts to the curved chute.

11. The apparatus of claim 2 further comprising:
a plurality of circular elements, each circular element having a tapered edge for scoring a nutshell; and
a plurality of curved chutes.

12. The apparatus of claim 11, wherein the plurality of circular elements are axially aligned.

13. The apparatus of claim 11, wherein each curved chute in the plurality of curved chutes is positioned at a different distance from a corresponding circular element than each other curved chute; whereby in use each curved chute receives nuts having a different size range than each other curved chute.

14. The apparatus of claim 11 further comprising a plurality of hoppers are connected to the plurality of curved chutes, whereby in use each hopper in the plurality of hoppers receives nuts having a different size range than each other hopper.

15. The apparatus of claim 1, wherein the drive mechanism comprises a handle.

16. The apparatus of claim 2, wherein the mounting structure and the curved chute are integrally formed with a body of the apparatus.

17. The apparatus of claim 1 further comprising a base plate.

18. The apparatus of claim 1, wherein the drive mechanism is hand operated.

19. The apparatus of claim 1, wherein the drive mechanism is motor operated.

20. The apparatus of claim 2 further comprising a housing enclosing the mounting structure, the circular element, and the curved chute.
